(19) United States
(12) Patent Application Publication
(10) Pub. No.: US 2011/0075956 A1
(43) Pub. Date: Mar. 31, 2011

(54) Sleeve for Oil Film Bearing

(75) Inventor: Thomas C. Wojtkowski, JR., Shrewsbury, MA (US)

(73) Assignee: MORGAN CONSTRUCTION COMPANY, Worcester, MA (US)

(21) Appl. No.: 12/568,401

(22) Filed: Sep. 28, 2009

(51) Int. Cl. F16C 33/02

(52) U.S. Cl. 384/276

(57) ABSTRACT

A sleeve is disclosed for use in an oil film bearing of the type employed to rotatably support the tapered neck of a roll in a rolling mill. The sleeve is machined from a hollow forging of a base metal with a cylindrical outer surface and a tapered inner surface adapted to be seated on the tapered roll neck. The tapered inner surface of the sleeve is coated with a layer of material that is chemically dissimilar with respect to the base metal.

### BACKGROUND

1. Field of the Invention

This invention relates to oil film bearings of the type employed to rotatably support the necks of rolls in rolling mills.

2. Background Discussion

A rolling mill oil film bearing typically comprises a sleeve axially received on and rotatably fixed to a roll neck. The sleeve is surrounded by a bushing contained in a chock mounted in a roll housing. In service, the sleeve is rotatably supported on a thin film of oil hydrodynamically maintained at the bearing load zone between the sleeve and the bushing.

The sleeves may be either internally cylindrical for use on cylindrical or “straight” roll necks, or they may be internally tapered for use on tapered roll necks. Moreover, the sleeves may be “self locking” or “non-locking”. Self locking sleeves are frictionally fixed to the roll necks by interference fits, whereas non-locking sleeves, which have taper angles of 3° or more per side, require keys or the like to effect a mechanical interengagement with the roll necks.

Experience has shown that in some applications, where the mating surfaces of non-locking sleeves and the tapered roll necks on which they are mounted have hardnesses that do not differ significantly, a type of galling will occur. Galling on the tapered interior sleeve surface is commonly referred to as “sleeve blackening”, and on the roll neck surface as “roll neck blackening”. This problem has existed for as long as tapered neck oil film bearings have been in use, and is most prevalent in large bearings having sleeves with outer diameters ≧500 mm, as well as in long-series bearings where the ratio of axial length to outer diameter (L/D) is at least 0.70, and in bearings rated for load zone loads equivalent to 4000 psi and higher.

### SUMMARY OF THE INVENTION

In accordance with the present invention, the tapered inner surfaces of non-locking oil film bearing sleeves are coated with a layer of friction reducing material that is chemically dissimilar with respect to the base metal of the sleeves.

### BRIEF DESCRIPTION OF THE DRAWINGS

FIG. 1 is a sectional view of an oil film bearing of the type employed in rolling mills to rotatably support the tapered necks of rolls; and

FIG. 2 is an enlarged view of the circled portion in FIG. 1.

### DETAILED DESCRIPTION

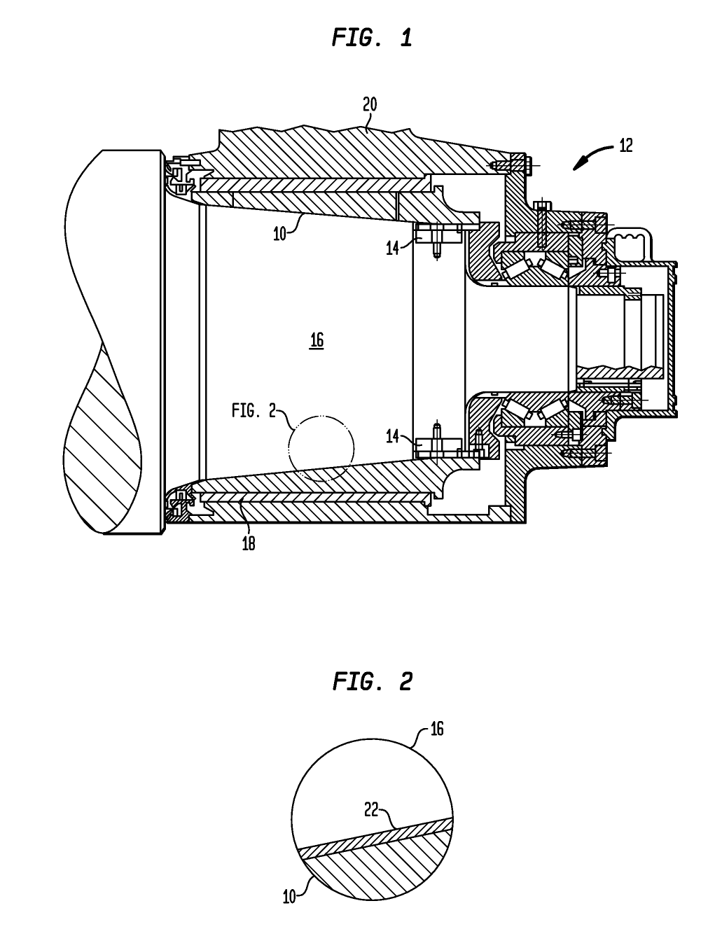

With reference to FIG. 1, a sleeve with a tapered inner surface is shown at 10 as a component part of a rolling mill oil film bearing 12. The sleeve 10 is removably received on a tapered section 16 of the roll neck and is rotatably fixed to the roll neck by keys 14 or the like. The sleeve is surrounded by a bushing 18 and is fixed in a bearing chock 20. In service, as previously noted, the sleeve is rotatably supported on a thin film of oil (not shown) hydrodynamically maintained at the bearing load zone between the sleeve and the bushing.

The sleeve 10 is machined from a hollow forging of a base metal, typically alloy steel, with a cylindrical outer surface and a tapered inner surface. In accordance with the present invention, and as can best be seen in FIG. 2, the tapered inner surface of the sleeve 10 is coated with a layer 22 of friction reducing material that is chemically dissimilar with respect to the base metal of the sleeve.

The layer 22 may be ablative, and may comprise molybdenum-disulfide affixed with a heat activated binding agent.

Alternatively, the layer 22 may comprise a chemical alteration of the base metal of the sleeve. Such chemical alterations may be achieved by various known processes, examples being vacuum furnace processes such as plasma nitriding. Other known processes, including for example ion sputtering or the like can be expected to achieve equivalent results.

The hardness of layer 22 will differ from that of the base metal. For example, a layer of molybdenum-disulfide will have a lower hardness level, whereas a layer produced by a vacuum furnace process such as plasma nitriding will have a higher hardness level. In both cases, layer 22 serves to alter the hardness relationship between the roll neck surface and the tapered interior sleeve surface to an extent sufficient to avoid or at least significantly minimize galling.

I claim:

1. A sleeve for use in an oil film bearing of the type employed to rotatably support the tapered neck of a roll in a rolling mill, said sleeve being machined from a hollow forging of a base metal with a cylindrical outer surface and a tapered inner surface adapted to be seated on said tapered neck, said tapered inner surface being coated with a layer of material that is chemically dissimilar with respect to said base metal.

2. The sleeve of claim 1 wherein said layer is ablative.

3. The sleeve of claim 2 wherein said layer comprises molybdenum-disulfide affixed to the surface with a heat activated binding agent.

4. The sleeve of claim 1 wherein said layer comprises a chemical alteration of said base metal.

5. The sleeve of claim 4 wherein said chemical alteration is produced by a vacuum furnace process.

6. The sleeve of claim 2 or 3 wherein said layer has a hardness level lower than the hardness level of the base metal.

7. The sleeve of claim 5 wherein said vacuum furnace process comprises plasma nitriding.

8. The sleeve of claim 5 or 7 wherein said layer has a hardness level higher than that of the base metal.

9. A sleeve for use in an oil film bearing of the type employed to rotatably support the tapered neck of a roll in a rolling mill, said sleeve being machined from a hollow forging of a base metal with a cylindrical outer surface and a tapered inner surface adapted to be seated on said tapered neck, said tapered inner surface being coated with a layer of material that is chemically dissimilar with respect to said base metal, said layer having a hardness which differs from the hardness of said base metal.
